(19) United States
(12) Patent Application Publication
(10) Pub. No.: US 2026/0109832 A1
(43) Pub. Date: Apr. 23, 2026

(54) LOW-RESILIENCE POLYURETHANE FOAM

(71) Applicants: INOAC CORPORATION, Nagoya-shi, Aichi (JP); INOAC SLIMFLEX CO., LTD., Nagoya-shi, Aichi (JP)

(72) Inventors: Masahito KOIDE, Chita-gun, Aichi (JP); Kento UCHIDA, Chita-gun, Aichi (JP); Eiji KARIYA, Chita-gun, Aichi (JP)

(21) Appl. No.: 19/116,372

(22) PCT Filed: Sep. 27, 2023
(86) PCT No.: PCT/JP2023/035217

§ 371 Date: Mar. 28, 2025

(30) Foreign Application Priority Data
Sep. 30, 2022 (JP) 2022-157572

(51) Int. Cl. C08J 9/30; C08G 18/10; C08G 18/42; C08G 18/48; C08G 18/69

(52) U.S. Cl. CPC C08J 9/30; C08G 18/10; C08G 18/4277; C08G 18/4825; C08G 18/694; C08G 18/698; C08G 2110/0008; C08J 2205/06; C08J 2375/08

(57) ABSTRACT

A low-resilience polyurethane foam is obtained by causing a reaction of a raw material composition containing a polyisocyanate component and a polyol component, and the polyisocyanate component contains an n-functional isocyanate (n≥3) and a bifunctional isocyanate prepolymer. The polyisocyanate component preferably has an average number of functional groups of 2.05 or more. The polyol component preferably includes one or more high molecular weight polyols, and one or more low molecular weight polyols.

### TECHNICAL FIELD

The present invention relates to a low-resilience polyurethane foam.

### BACKGROUND ART

Polyurethane refers to a polymer compound that contains urethane bonds (—NH—C(O)O—). Polyurethane is generally obtained by causing a reaction of a hydroxyl group (—OH) of a polyol with an isocyanate group (—NCO) of a polyisocyanate. It is known that polyurethane exhibits diverse properties by optimizing the type of polyol and/or polyisocyanate. Therefore, polyurethane is applied to various automobile parts, synthetic leather, paint, adhesives, and the like. Additionally, polyurethane foam, which is obtained by foaming polyurethane, is applied to heat insulating materials, cushioning materials, and the like.

Polyurethane foam is broadly classified into:
(a) soft polyurethane foam having open cells, small compression hardness, and flexibility;
(b) rigid polyurethane foam that has closed cells, is highly crosslinked in molecular structure, and does not have high elasticity like a soft polyurethane foam; and
(c) semi-rigid polyurethane foam having intermediate properties between rigid and soft polyurethane foams.

Among these, soft polyurethane foam exhibits viscoelasticity. Additionally, soft polyurethane foam having reduced elasticity and increased viscosity is also particularly referred to as “low-resilience (SR: Slow Recovery) polyurethane foams”. Low-resilience polyurethane foam, due to its excellent shock absorption properties, is used in shock-absorbing materials, protective mats, cushioning materials, vibration-absorbing materials, shoe insoles, shoe sole cushions, pillow cushions, seat cushions, chair cushions, bedding cushions, and the like.

Various proposals have been made regarding such low-resilience polyurethane foams. For example, Patent Document 1 discloses a low-resilience foamed polyurethane resin obtained by causing a reaction of a composition containing a polyol having an average number of functional groups of 2 to 3 and a hydroxyl value of 20 to 200 mgKOH/g, isocyanate, a resin microballoon containing no chlorine atom, and a catalyst.

The document describes that:
(A) low hardness polyurethane has adhesiveness and sticks to the hands, making it difficult to use;
(B) when a microballoon is added to low hardness polyurethane, the low hardness polyurethane hardly sticks to the hands, but the microballoon floats during curing of the urethane resin, and thus the density difference occurs between the upper part and the lower part of the molded article; and
(C) when a mixture containing 10 wt % or more of an alkylene oxide adduct of a polyhydric phenol having 2 to 3 functional groups is used as the polyol, the density difference between the upper part and the lower part of the molded article due to floating of the microballoon can be reduced.

Patent Document 2 discloses a sheet which is not a low-resilience polyurethane foam but includes a skin layer composed of a polyurethane film and a foam layer composed of a polyurethane foam, in which an average cell diameter of the polyurethane foam is 50 μm to 300 μm.

The same document describes that a sheet including a skin layer and a foam layer is excellent in abrasion resistance and shock absorption properties.

Low-resilience polyurethane foam has come to be used as a cushioning material for smartphones, game machines, and the like. The cushioning material is extremely thin, with a thickness of about 0.2 to 1.0 mm, and the required physical properties include low compressive residual strain, high tensile strength, and the like in addition to the SR properties. However, there has been no conventional example of a low-resilience polyurethane foam that satisfies all these requirements.

In particular, the SR properties and the tensile strength are in a contradictory relationship. That is, when the SR properties are to be developed, the tensile strength is decreased, and when the tensile strength is increased, the SR properties are not developed. Therefore, it is generally difficult to achieve both the SR properties and the tensile strength.

### CITATION LIST

### Patent Document

Patent Document 1: Japanese Patent Application Laid-Open No. 2016-113537
Patent Document 2: Japanese Patent Application Laid-Open No. 2022-100615

### SUMMARY OF INVENTION

### Technical Problem

A problem to be solved by the present invention is to provide a low-resilience polyurethane foam having excellent slow recovery properties.

Another problem to be solved by the present invention is to provide a low-resilience polyurethane foam having high tensile strength in addition to excellent slow recovery properties.

Further, still another problem to be solved by the present invention is to provide a low-resilience polyurethane foam having a small compressive residual strain in addition to excellent low resilience.

### Solution to Problem

In order to solve the above problems, a low-resilience polyurethane foam according to the present invention is
obtained by causing a reaction of a raw material composition containing a polyisocyanate component and a polyol component, and
the polyisocyanate component contains an n-functional isocyanate (n≥3) and a bifunctional isocyanate prepolymer.

### Advantageous Effects of Invention

In the case of producing a low-resilience polyurethane foam, when a mixture containing an n-functional isocyanate and a bifunctional isocyanate prepolymer is used as a polyisocyanate component, excellent SR properties are exhibited. This is considered to be because the use of a bifunctional isocyanate prepolymer having a long molecular length as one of the polyisocyanate components reduced the rigidity of the chain structure of the polyurethane.

In addition, in the case of producing a low-resilience polyurethane foam using a raw material mixture containing an n-functional isocyanate and a bifunctional isocyanate prepolymer, when the isocyanate index is relatively increased and/or the number of branches of the raw material composition is optimized, the tensile strength is improved and/or the compressive residual strain is reduced while excellent SR properties are maintained.

It is considered that the tensile strength was improved because the number of crosslinking points was maintained at an appropriate value by optimizing the isocyanate index and/or the number of branches.

It is considered that the compressive residual strain is reduced because
(a) by relatively increasing the isocyanate index, reactivity was improved, the residual polyol component decreased, and tackiness was reduced, and
(b) by optimizing the number of branches, the required minimum elasticity was ensured.

### DESCRIPTION OF EMBODIMENTS

Hereinafter, an embodiment of the present invention will be described in detail.

### [1. Low-Resilience Polyurethane Foam]

The low-resilience polyurethane foam according to the present invention is obtained by causing a reaction of a raw material composition containing a polyisocyanate component and a polyol component that satisfy predetermined conditions.

### [1.1. Raw Material Composition]

### [1.1.1. Polyisocyanate Component]

The “polyisocyanate component” is one of main raw materials for producing the low-resilience polyurethane foam according to the present invention, and refers to a mixture of two or more polyisocyanates.

In the present invention, the polyisocyanate component contains an n-functional isocyanate (n≥3) and a bifunctional isocyanate prepolymer. The polyisocyanate component may be composed of only an n-functional isocyanate and a bifunctional isocyanate prepolymer, or may further contain a bifunctional isocyanate in addition to these.

### [A. N-Functional Isocyanate]

The “n-functional isocyanate” refers to a polyisocyanate having 3 or more isocyanate groups.

When the raw material composition contains the n-functional isocyanate, the number of branches of the raw material composition becomes an appropriate value, and the polymer chain is appropriately crosslinked. As a result, it is considered that the tensile strength of the low-resilience polyurethane foam is improved, or the compressive residual strain is reduced.

Examples of the n-functional isocyanate include
a polynuclear form of 4,4′-diphenylmethane diisocyanate (4,4′-MDI),
1-methylbenzol-2,4,6-triisocyanate,
1,3,5-trimethylbenzol-2,4,6-triisocyanate,
biphenyl-2,4,4′-triisocyanate,
diphenylmethane-2,4,4′-triisocyanate,
methyldiphenylmethane-4,6,4′-triisocyanate,
4,4′-dimethyldiphenylmethane-2,2′,5,5′-tetraisocyanate, and
triphenylmethane-4,4′,4″-triisocyanate.

The raw material composition may contain any one of these n-functional isocyanates, or may contain two or more of these n-functional isocyanates.

### [B. Bifunctional Isocyanate Prepolymer]

The “isocyanate prepolymer” refers to a compound which is obtained by causing a reaction of a polyol with a polyisocyanate and has an isocyanate group at the terminal.

The “bifunctional isocyanate prepolymer” refers to a compound having two isocyanate groups in the isocyanate prepolymer. In other words, the “bifunctional isocyanate prepolymer” refers to a linear compound (OCN—R′—NH—C(O)O—R—O(O)C—NH—R′—NCO) obtained by causing a reaction of one molecule of diol (HO—R—OH) with two molecules of bifunctional isocyanate (OCN—R′—NCO).

Since the bifunctional isocyanate prepolymer has a long molecular length, when a low-resilience polyurethane foam is produced using the bifunctional isocyanate prepolymer, the rigidity of the chain structure of the polyurethane is reduced. As a result, it is considered that the SR properties of the low-resilience polyurethane foam is further improved.

In the present invention, the type of the bifunctional isocyanate prepolymer is not particularly limited, and an optimum bifunctional isocyanate prepolymer can be selected according to the purpose.

Examples of the bifunctional isocyanate prepolymer include
(a) urethane-modified MDI, allophanate-modified MDI, biuret-modified MDI, isocyanurate-modified MDI, urea-modified MDI, and carbodiimide-modified MDI, and
(b) urethane-modified TDI, allophanate-modified TDI, biuret-modified TDI, isocyanurate-modified TDI, urea-modified TDI, and carbodiimide-modified TDI.

The raw material composition may contain any one of these bifunctional isocyanate prepolymers, or may contain two or more of these bifunctional isocyanate prepolymers.

### [C. Bifunctional Isocyanate]

The “bifunctional isocyanate” refers to a compound having two isocyanate groups and a compound other than a bifunctional isocyanate prepolymer.

For example, commercially available polymeric MDI further contains 4,4′-MDI in addition to the polynuclear form of 4,4′-MDI. The commercially available MDI prepolymer further contains unreacted 4,4′-MDI in addition to a linear compound (urethane-modified MDI) obtained by causing a reaction of 4,4′-MDI with a low molecular weight diol.

The raw material composition may contain one or more bifunctional isocyanates in addition to the n-functional isocyanate and the bifunctional isocyanate prepolymer described above. Specific examples of the bifunctional isocyanate include the following.

### (a) Bifunctional Aromatic Isocyanate:

2,4-tolylene diisocyanate and 2,6-tolylene diisocyanate,
m-phenylene diisocyanate and p-phenylene diisocyanate,
4,4′-diphenylmethane diisocyanate (4,4′-MDI),
2,4′-diphenylmethane diisocyanate,
2,2′-diphenylmethane diisocyanate and xylylene diisocyanate,
3,3′-dimethyl-4,4′-biphenylene diisocyanate, and
3,3′-dimethoxy-4,4′-biphenylene diisocyanate.

### (b) Bifunctional Alicyclic Isocyanate:

cyclohexane-1,4-diisocyanate and isophorone diisocyanate,
dicyclohexylmethane-4,4′-diisocyanate, and
methylcyclohexanediisocyanate.

### (c) Bifunctional Aliphatic Isocyanate:

butane-1,4-diisocyanate and hexamethylene diisocyanate, and
isopropylene diisocyanate, methylene diisocyanate, and lysine isocyanate.

### [D. Average Number of Functional Groups in Polyisocyanate Component]

The “average number of functional groups in the polyisocyanate component” refers to an average value of the number of functional groups per polyisocyanate molecule.

The average number of functional groups in the polyisocyanate component affects the SR properties, the tensile strength, and/or the compressive residual strain. Therefore, it is preferable to select an optimum value for the average number of functional groups of the polyisocyanate component according to the purpose.

In general, as the average number of functional groups of the polyisocyanate component increases, the tensile strength increases and/or the compressive residual strain decreases. In order to obtain such an effect, the average number of functional groups of the polyisocyanate component is preferably 2.05 or more. The average number of functional groups is more preferably 2.07 or more, and still more preferably 2.10 or more.

Meanwhile, when the average number of functional groups of the polyisocyanate component is too large, the SR properties may deteriorate. Therefore, the average number of functional groups in the polyisocyanate component is preferably 3.00 or less. The average number of functional groups is more preferably 2.90 or less, 2.80 or less, 2.70 or less, 2.60 or less, 2.50 or less, or 2.40 or less.

### [E. Isocyanate Index]

The “isocyanate index” refers to a value obtained by multiplying the ratio of the equivalent of isocyanate groups of the polyisocyanate in the raw material composition with respect to the equivalent of active hydrogen groups in the raw material composition by 100.

In general, as the isocyanate index increases, the tensile strength increases, but the SR properties decrease. However, since polyisocyanates having different numbers of functional groups are used and the molecular structure of the polyisocyanate is optimized, the low-resilience polyurethane foam according to the present invention exhibits excellent SR properties despite having a higher isocyanate index than the conventional one. In particular, when the average number of functional groups of the polyisocyanate component is optimized, excellent SR properties, high tensile strength, and low compressive residual strain can be compatible at a high level.

In order to obtain high tensile strength, the isocyanate index is preferably 80 or more. The isocyanate index is more preferably 85 or more, 90 or more, or 95 or more.

Meanwhile, when the isocyanate index is too high, the number of crosslinking points is excessive, and the SR properties may deteriorate. Therefore, the isocyanate index is preferably 130 or less. The isocyanate index is more preferably 125 or less, 120 or less, or 115 or less.

### [1.1.2. Polyol Component]

The “polyol component” refers to another one of the main raw materials for producing the low-resilience polyurethane foam according to the present invention.

The raw material composition may contain one kind of polyol or two or more kinds thereof.

### [A. Materials]

The kind of the polyol contained in the polyol component is not particularly limited, and an optimum material can be selected according to the purpose. The polyol may be any of an ether-based polyol, an ester-based polyol, an ether-ester-based polyol, and a polymer polyol. Specific examples of the polyol include the following.

Examples of the ether-based polyol include
(a) polyhydric alcohols such as ethylene glycol, diethylene glycol, propylene glycol, dipropylene glycol, butylene glycol, neopentyl glycol, glycerin, pentaerythritol, trimethylolpropane, sorbitol, and sucrose, and
(b) polyether polyol in which alkylene oxide such as ethylene oxide or propylene oxide is added to polyhydric alcohol.

Examples of the ester-based polyol include
(a) a polyester polyol obtained by polycondensation of an aliphatic carboxylic acid such as malonic acid, succinic acid, or adipic acid or an aromatic carboxylic acid such as phthalic acid with an aliphatic glycol such as ethylene glycol, diethylene glycol, or propylene glycol, and
(b) phthalate ester polyol.

Examples of the polymer polyol include
(a) a dispersion obtained by dispersing polymer particles obtained by polymerizing an ethylenically unsaturated monomer such as acrylonitrile or styrene in a polyol such as a polyether polyol, and
(b) core-shell rubber (CSR) dispersed polyol.

The CSR-dispersed polyol refers to a polyol in which core-shell rubber (CSR) particles are dispersed. Specifically, the core-shell rubber particles refer to rubber particles in which a polymer different from the core component is graft-polymerized on the surface of a particulate core component mainly composed of a crosslinked rubber-like polymer to coat a part or the whole of the surface of the particulate core component with the shell component.

Examples of the core component include crosslinked rubber particles. The type of rubber is not limited, and examples of the crosslinked rubber particles include butadiene rubber, acrylic rubber, silicone rubber, butyl rubber, nitrile rubber, styrene rubber, synthetic natural rubber, and ethylene propylene rubber.

Examples of the shell component include a polymer polymerized from one or more monomers selected from the group consisting of an acrylic acid ester, a methacrylic acid ester, and an aromatic vinyl compound.

It is preferable that the shell component is graft-polymerized with the core component and chemically bonded to a polymer constituting the core component. In addition, in consideration of dispersibility with a polyol, it is preferable to contain a methyl methacrylate butadiene-ethylene copolymer (MBS)-based polymer as the core-shell rubber particles.

### [B. Number Average Molecular Weight, Molecular Weight]

The low-resilience polyurethane foam may be produced using one kind of polyol or two or more kinds of polyols.

When the low-resilience polyurethane foam is produced using two or more polyols, the polyol component may be:
(a) a mixture of two or more polyols having the same number average molecular weight or molecular weight, or
(b) a mixture of two or more kinds of polyols having different number average molecular weights or molecular weights.

In order to obtain a low-resilience polyurethane foam excellent in SR properties, the polyol component preferably includes
one or more high molecular weight polyols, and
one or more low molecular weight polyols.

Here,
the “high molecular weight polyol” refers to a polyol having a number average molecular weight of 1,000 or more, and
the “low molecular weight polyol” refers to a polyol having a number average molecular weight or molecular weight of less than 1,000.

The “molecular weight” refers to a formula weight based on a chemical formula.

The number average molecular weight (Mni) of each of the i-th (i≥1) high molecular weight polyols is preferably 1,500 or more, and more preferably 2,000 or more.

The number average molecular weight or the molecular weight (Mnj) of each of the j-th (j≥1) low molecular weight polyols is preferably 800 or less, and more preferably 600 or less, respectively.

### [C. Number Average Molecular Weight Ratio]

In a case where the polyol component refers to a mixture of high molecular weight polyols and low molecular weight polyols,
the “number average molecular weight ratio of polyol component” can expressed as a ratio (=Mn_{Htotal}/Mn_{Ltotal}) of the total number average molecular weight (Mn_{Htotal}) of the high molecular weight polyols with respect to the total number average molecular weight (Mn_{Ltotal}) of the low molecular weight polyols.

When the number average molecular weight of the i-th (i≥1) high molecular weight polyol is represented by Mni, and the number ratio of the i-th high molecular weight polyol to the entire high molecular weight polyols is represented by ni, the relationship can be expressed as

$${Mn}_{Htotal} = \sum ni \times Mni .$$

Similarly, when the number average molecular weight or the molecular weight of the j-th (j≥1) low molecular weight polyol is represented by Mnj, and the number ratio of the j-th low molecular weight polyol to the entire low molecular weight polyols is represented by nj, the relationship can be expressed as

$${Mn}_{Ltotal} = \sum nj \times Mnj .$$

The number average molecular weight ratio of the polyol component mainly affects the SR properties of the low-resilience polyurethane foam. When a low-resilience polyurethane foam is produced using two or more polyols having different molecular weights, generally, the SR properties are improved as the number average molecular weight ratio increases. In order to obtain such an effect, the number average molecular weight ratio of the polyol component is preferably 2.0 or more. The number average molecular weight ratio is more preferably 2.5 or more, 3.0 or more, 3.5 or more, or 4.0 or more.

Meanwhile, when the number average molecular weight ratio of the polyol component becomes too large, the following issues may arise:
(a) Due to the differences in the glass transition points of each polyol, temperature dependence increases.
(b) The hard segments and the soft segments of the resin structure separate, and the SR properties are impaired.
(c) compressive residual strain deteriorates. Therefore, the number average molecular weight ratio is preferably 10 or less.

### [D. Content of Low Molecular Weight Polyol]

In a case where the polyol component refers to a mixture of high molecular weight polyols and low molecular weight polyols,
the “content of the low molecular weight polyol” can be expressed as a proportion (=W_{L}×100/W_{H}) of the total weight (W_{L}) of the low molecular weight polyols with respect to the total weight (W_{T}) of the polyol component.

The content of the low molecular weight polyol mainly affects the SR properties of the low-resilience polyurethane foam. When the content of the low molecular weight polyol is too small, the SR properties may deteriorate. Therefore, the content of the low molecular weight polyol is preferably 40.0 mass % or more. The content is more preferably 45.0 mass % or more, or 50 mass % or more.

Meanwhile, when the content of the low molecular weight polyol is excessive, the SR properties may rather deteriorate. Therefore, the content of the low molecular weight polyol is preferably 75.0 mass % or less. The content is more preferably 70.0 mass % or less, or 65.0 mass % or less.

### [1.1.3. Number of Branches]

The “number of branches” refers to the number of branches per 1 mol of molecules contained in the raw material composition, and is represented by the following formula.

Number of branches (number/mol)=Σ(number of functional groups−2)×(number of parts to be added/molecular weight)

The number of branches of the raw material composition affects the SR properties, tensile strength, and compressive residual strain. In general, the smaller the number of branches, the more easily the SR properties are exhibited. However, when the number of branches is too small, the tensile strength may decrease, or the compressive residual strain may decrease. Therefore, the number of branches is preferably 0.010 or more. The number of branches is more preferably 0.012 or more, 0.014 or more, or 0.016 or more.

Meanwhile, when the number of branches is excessively large, the SR properties may deteriorate. Therefore, the number of branches is preferably 0.050 or less. The number of branches is more preferably 0.048, 0.046 or less, or 0.044 or less.

### [1.1.4. Other Components]

The raw material composition for producing the low-resilience polyurethane foam may contain the following components in addition to the polyisocyanate component and the polyol component described above. The addition amount of each component is not particularly limited, and it is preferable to select an optimum addition amount according to the purpose.

### [A. Resinification Catalyst]

The raw material composition may contain a resinification catalyst. The resinification catalyst is a catalyst for accelerating the reaction between the OH group of the polyol and the NCO group of the polyisocyanate. In the present invention, the type of the resinification catalyst is not particularly limited. Examples of the resinification catalyst include an amine-based catalyst and a metal catalyst.

Examples of the amine-based catalyst include
1,2-dimethylimidazole and 1-methylimidazole,
N·(N′,N′-dimethylaminoethyl)-morpholine and tetramethylguanidine,
dimethylaminoethanol and triethylenediamine,
N-methyl-N′-(2hydroxyethyl)-piperazine,
N,N,N′,N′-tetramethylpropane 1,3-diamine,
N,N,N′,N′-tetramethylethylenediamine,
N,N,N′,N″,N″-pentamethyl-(3-aminopropyl)ethylenediamine,
N,N′-dimethylpiperazine,
N,N,N′,N′-tetramethylhexane-1,6-diamine,
N,N,N′,N″,N″-pentamethyldipropylene-triamine,
N-(2-hydroxyethyl)morpholine,
ethylene glycol bis(3-dimethyl)-aminopropyl ether,
N,N-dimethylcyclohexylamine, and
N-methyl-N′-(2dimethylamino)ethylpiperazine.

Examples of the metal catalyst include
(a) tin catalysts such as stannous octoate and dibutyltin dilaurate,
(b) phenylmercuric propionate, and
(c) lead octenoate.

### [B. Foam Stabilizer]

The raw material composition may contain a foam stabilizer. The foam stabilizer facilitates dispersion of entrainment gas when mechanically foaming polyurethane, stabilizes bubbles, and adjusts the bubble structure. In the present invention, the type of the foam stabilizer is not particularly limited.

Examples of the foam stabilizer include
(a) a silicone-based foam stabilizer,
(b) a fluorine-containing compound-based foam stabilizer,
(c) anionic surfactants such as sodium dodecylbenzenesulfonate and sodium lauryl sulfate, and
(d) phenol-based compound.

### [C. Filler]

The raw material composition may contain a filler. The filler is for increasing the volume of the polyurethane foam, reducing the amount of the polyurethane raw material used per unit volume, and reducing the cost of the polyurethane foam. In the present invention, the kind of the filler is not particularly limited.

Examples of the filler include aluminum hydroxide, calcium carbonate, talc, and clay.

### [D. Moisture Absorbent]

The raw material composition may contain a moisture absorbent. The moisture absorbent is for removing moisture contained in the composition and suppressing the polyisocyanate from reacting with moisture. When the polyisocyanate reacts with moisture, CO₂ gas is generated, and it may be difficult to control bubbles. In the present invention, the kind of the moisture absorbent is not particularly limited.

Examples of the moisture absorbent include molecular sieve, synthetic zeolite, silica powder, alumina powder, lithium hydroxide powder, and barium hydroxide powder.

### [E. Antioxidant]

The raw material composition may contain an antioxidant. The antioxidant is for suppressing deterioration of polyurethane due to oxidation. In the present invention, the type of the antioxidant is not particularly limited.

Examples of the antioxidant include hindered phenol-based antioxidants, amine-based antioxidants, sulfur-based antioxidants, and phosphorus-based antioxidants.

### [1.2. Reaction of Raw Material Composition]

The low-resilience polyurethane foam according to the present invention is produced using a mechanical froth method. The “mechanical froth method” means a method in which:
(a) by using a high-shear mixer to mix the raw material composition while injecting an inert gas, a foaming raw material composition containing fine bubbles is obtained,
(b) the foaming raw material composition is applied to the surface of a base material (for example, a PET film), and
(c) the coating film is heated to a predetermined temperature and cured.

In the present invention, the reaction conditions of the raw material composition are not particularly limited, and optimal conditions can be selected according to the purpose.

### [1.3. Characteristics]

### [1.3.1. Thickness]

In the present invention, the thickness of the low-resilience polyurethane foam is not particularly limited, and an optimum thickness can be selected according to the purpose. When the low-resilience polyurethane foam is used as a cushioning material for electronic and electric devices, the thickness thereof is preferably as thin as possible.

When the low-resilience polyurethane foam according to the present invention is used, not only excellent SR properties but also a sheet having a thickness of 2.0 mm or less can be produced. When the production conditions are optimized, the thickness is 1.5 mm or less, or 1.0 mm or less.

### [1.3.2. Recovery Speed]

The “recovery speed” refers to a time until the shape of the sample is restored when a load of 1 kg is applied to the compression surface having a diameter of 15 mm by a constant pressure loader for 5 seconds and then the load is released. A large recovery speed (long restoration time) indicates excellent SR properties.

In the low-resilience polyurethane foam according to the present invention, when the molecular structure of the polyisocyanate used as a raw material, the average number of functional groups of the polyisocyanate, the isocyanate index, the number of branches, and the like are optimized, the recovery speed can be increased. When the production conditions are optimized, the recovery speed is 1.5 seconds or more. When the production conditions are further optimized, the recovery speed is 3.0 seconds or more, 6.0 seconds or more, or 10 seconds or more.

### [1.3.3. Compressive Residual Strain]

The “compressive residual strain” refers to a value measured based on JIS K6401:2011.

In the low-resilience polyurethane foam according to the present invention, when the molecular structure of the polyisocyanate used as a raw material, the average number of functional groups of the polyisocyanate, the isocyanate index, the number of branches, and the like are optimized, the compressive residual strain can be reduced. When the production conditions are optimized, the compressive residual strain is 20% or less. When the production conditions are further optimized, the compressive residual strain is 10% or less, or 5% or less.

### [1.3.4. Tensile Strength]

The “tensile strength” refers to a value measured based on JIS K 6251:2010.

In the low-resilience polyurethane foam according to the present invention, when the molecular structure of the polyisocyanate used as a raw material, the average number of functional groups of the polyisocyanate, the isocyanate index, the number of branches, and the like are optimized, the tensile strength can be increased. When the production conditions are optimized, the tensile strength is 0.3 MPa or more. When the production conditions are further optimized, the tensile strength is 0.4 MPa or more, or 0.5 MPa or more.

### [1.3.5. Elongation]

The “elongation” refers to a value measured based on JIS K 6251:2010.

In the low-resilience polyurethane foam according to the present invention, when the molecular structure of the polyisocyanate used as a raw material, the average number of functional groups of the polyisocyanate, the isocyanate index, the number of branches, and the like are optimized, the elongation can be increased. When the production conditions are optimized, the elongation is 200% or more. When the production conditions are further optimized, the elongation is 250% or more, or 300% or more.

### [1.3.6. Density]

The “density” refers to a value measured based on JIS K 6401:2011.

The low-resilience polyurethane foam according to the present invention is produced by a mechanical froth method, and therefore has a relatively low density. When the production conditions are optimized, the density is 600 kg/m³ or less. When the production conditions are further optimized, the density is 550 kg/m³ or less, 450 kg/m³ or less, 250 kg/cm³ or less, 200 kg/m³ or less, or 150 kg/m³ or less.

### [1.3.7. Average Cell Diameter]

The “average cell diameter” refers to an average value of equivalent circle diameters of cells appearing in a cross section of a polyurethane foam.

Since the low-resilience polyurethane foam according to the present invention is produced using a mechanical froth method, fine cells are uniformly dispersed in the polyurethane foam. When the production conditions are optimized, the average cell diameter is from 50 μm to 300 μm. When the production conditions are further optimized, the average cell diameter is preferably 50 μm to 250 μm, and more preferably 50 μm to 200 μm.

### [1.4. Application]

The low-resilience polyurethane foam according to the present invention can be used for various applications. Examples of applications of the low-resilience polyurethane foam according to the present invention include, for example, shock-absorbing materials, protective mats, cushioning materials, vibration-absorbing materials, shoe insoles, shoe sole cushions, pillow cushions, seat cushions, chair cushions, and bedding cushions.

The low-resilience polyurethane foam according to the present invention not only exhibits excellent slow recovery properties but also has high tensile strength despite being thin, making it particularly suitable as a cushioning material for electronic and electrical devices. Examples of the cushioning material for electronic and electric devices include
(a) a cushioning material that is disposed on a back surface side of various image display devices such as a liquid crystal display and absorbs an impact applied to the display device, and
(b) a cushioning material for a display member such as a touch panel used for mobile communication devices (for example, a mobile phone, a smartphone, or a personal digital assistant), a camera, or a lens.

The low-resilience polyurethane foam according to the present invention can be used not only as a cushioning material but also as a base material of an adhesive tape, a gasket, or a sealing material.

### [2. Action]

Conventional low-resilience polyurethane foams are generally produced using a raw material composition in polyol-excess (a raw material composition having an isocyanate index of less than 80). In the low-resilience polyurethane foam obtained in this manner, since a large amount of unreacted OH groups remain, the SR properties are high, but the tensile strength is low, and the compressive residual strain is also large. On the other hand, when the isocyanate index is simply increased, the tensile strength is increased, the compressive residual strain is decreased, but the SR properties deteriorate.

On the other hand, the case of producing a low-resilience polyurethane foam, when a mixture containing an n-functional isocyanate and a bifunctional isocyanate prepolymer is used as a polyisocyanate component, excellent SR properties are exhibited. This is considered to be because the use of a bifunctional isocyanate prepolymer having a long molecular length as one of the polyisocyanate components reduced the rigidity of the chain structure of the polyurethane.

In addition, in the case of producing a low-resilience polyurethane foam using a raw material mixture containing an n-functional isocyanate and a bifunctional isocyanate prepolymer, when the isocyanate index is relatively increased and/or the number of branches of the raw material composition is optimized, the tensile strength is improved and/or the compressive residual strain is reduced while excellent SR properties are maintained.

It is considered that the tensile strength was improved because the number of crosslinking points was maintained at an appropriate value by optimizing the isocyanate index and/or the number of branches.

It is considered that the compressive residual strain is reduced because
(a) by relatively increasing the isocyanate index, reactivity was improved, the residual polyol component decreased, and tackiness was reduced, and
(b) by optimizing the number of branches, the required minimum elasticity was ensured.

### EXAMPLES

### Examples 1 to 29, Comparative Examples 1 to 7

### [1. Preparation of Sample]

Table 1 shows a list of the raw materials used. Raw materials shown in Table 1 were blended at a predetermined ratio. The raw material composition was charged into a mixing head, and stirred and mixed to be homogeneous while being mixed with an inert gas (nitrogen) to obtain a foaming raw material composition containing fine bubbles. The foaming raw material composition was applied onto a PET film, and the coating film was heated and cured at 200° C.

The number average molecular weight was calculated using the following formula.

Number average molecular weight=(56100×number of functional groups)/hydroxyl value

In Table 1, the number average molecular weight of the CSR-dispersed polyol represents the number average molecular weight of PPG as a dispersion medium. Similarly, the number average molecular weight of the polymer polyol represents the number average molecular weight of PPG as a dispersion medium.

Further, the CSR particles contained in the CSR-dispersed polyol are methyl methacrylate butadiene-styrene copolymer (MBS)-based polymers.

TABLE 1

| | | | Number | | |
|---|---|---|---|---|---|
| | | | average | Number of | Hydroxyl |
| | | | molecular | functional | value |
| Summary | Type | Product name/Manufacturer | weight | groups | (mgKOH/g) |
| Polyol | Polyether polyol (PPG) | PP-2000/Sanyo Chemical | 2000 | 2.0 | 56.1 |
| | | Industries, Ltd. | | | |
| | Polyether polyol (PPG) | PP-400/Sanyo Chemical Industries, | 400 | 2.0 | 280.5 |
| | | Ltd. | | | |
| | CSR-dispersed polyol | MX-714/Kaneka Corporation | 400 | 2.0 | 171.0 |
| | (CSR:PPG = 40:60) | | | | |
| | Polycaprolactone polyol | PLACCEL205U/Daicel ChemTech | 534 | 2.0 | 210.0 |
| | Polycaprolactone polyol | PLACCEL305/Daicel ChemTech | 552 | 3.0 | 305.0 |
| | PPG + Fe catalyst (0.25%) | LT-Cat/PAN Chemical | 3000 | 3.0 | 56.1 |
| | Polymer polyol | EX-914/Asahi Glass Co., Ltd. | 3000 | 3.0 | 41.9 |
| Isocyanate | Polymeric MDI (NCO %: | 500B/BASF INOAC Polyurethanes | 320 | 2.4 | — |
| | 31.5%) | Ltd. | | | |
| | MDI prepolymer (NCO %: | MP-102/BASF INOAC | 366 | 2.0 | — |
| | 23.0%) | Polyurethanes Ltd. | | | |
| Additive | Foam stabilizer | SZ-1952/Dow Corning Toray Co., | — | 1.0 | 40.0 |
| | | Ltd. | | | |
| | Filler (aluminum | CW-325LV/Sumitomo Chemical | — | — | — |
| | hydroxide) | Co., Ltd. | | | |
| | Moisture absorbent | 3A MS/Union Showa K.K. | — | — | — |
| | (molecular sieve) | | | | |
| | Antioxidant | IR-1135/BASF Japan Ltd. | — | — | — |

### [2. Test Method]

### [2.1. Recovery Speed]

A load of 1 kg (compression surface: φ15 mm) was applied onto each sample for 5 seconds with a constant pressure loader (manufactured by ASKER, CL-150). Thereafter, the load was released, and the recovery speed was measured.

### [2.2. Compressive Residual Strain]

The compressive residual strain was measured based on JIS K 6401:2011.

### [2.3. Density]

The density was measured based on JIS K 6401:2011.

### [2.4. Tensile Strength]

The tensile strength was measured based on JIS K 6251:2010.

### [2.5. Elongation]

Elongation was measured based on JIS K 6251:2010.

### [2.6. 180° Peeling]

A sample having a width of 30 mm and a length of 125 mm was attached to the surface of a reinforcing plate made of ABS resin with a double-sided tape interposed therebetween. The size of the double-sided tape was the same as the size of the sample. Next, a PET film having a width of 24 mm and a length of 130 mm was attached to the surface of the sample with a double-sided tape interposed therebetween. Further, a PET film was pressed on the sample surface. The pressing was performed by reciprocating a roll of 2 kg twice on the surface of the PET film. After pressing, the sample was left for 24 hours.

Next, the PET film was pulled in a direction of 180° with respect to the bonding surface. The test speed was 300 mm/min. The force (N/24 mm) at which the PET film was peeled off in a section of 50 mm at the center of the sample was measured.

### [2.7. Shear Strength]

An SUS plate was attached to each of both surfaces of a sample of 25 mm×25 mm with a double-sided tape interposed therebetween. The size of the double-sided tape was the same as the size of the sample. The SUS plate was pulled up and down, and the force (N) when the sample was shearing fractured was measured.

### [2.5. 25% CLD Hardness]

The 25% CLD hardness was measured based on JIS K 6254:2010.

### [3. Results]

The results are shown in Tables 2 to 4. Tables 2 to 4 also show the raw material blending of each sample. Tables 2 to 4 show the following.
(1) In the case of Comparative Examples 1 to 5, as the isocyanate index decreased, the recovery speed increased and the elongation increased, but the tensile strength tended to decrease. This is considered to be because the number of crosslinking points decreases as the isocyanate index decreases.
(2) In Examples 1 to 7, although having the same isocyanate index as that of Comparative Example 1, the recovery speed was higher and the tensile strength was also higher than that of Comparative Example 1. This is believed to be because the use of the bifunctional isocyanate prepolymer reduced the rigidity of the chain structure of the polyurethane.
(3) In the case of Examples 1 to 7, the recovery speed increased as the average number of functional groups in the polyisocyanate component decreased, but the tensile strength showed a maximum when the average number of functional groups in the polyisocyanate component was 2.132 (Example 6). This is considered to be because when the average number of functional groups becomes too small, the number of crosslinking points becomes excessively small.
(4) In Examples 8 to 14, as compared with Examples 1 to 7 in which the average number of functional groups in the polyisocyanate component was the same, the tensile strength was increased, but the recovery speed tended to be slightly decreased. This is believed to be because the isocyanate index of Examples 8 to 14 is higher than that of Examples 1 to 7.
(5) In Examples 15 to 19, as compared with Examples 1 to 5 in which the average number of functional groups in the polyisocyanate component was the same, the recovery speed tended to increase, but the tensile strength tended to decrease. This is believed to be because the isocyanate index of Examples 15 to 19 is smaller than that of Examples 1 to 5.
(6) In Comparative Examples 6 and 7, the 1800 peel strength was slightly low. On the other hand, Examples 20 to 29 exhibited high 1800 peel strength and high shear strength while maintaining a high recovery speed. This is considered to be because a low molecular weight polyol containing core-shell rubber (CSR) particles and a low molecular weight polyol having 3.0 functional groups were further added to the raw material.

TABLE 2

| | | Comparative | Comparative | Comparative | Comparative | Comparative | Example |
|---|---|---|---|---|---|---|---|
| | | Example 1 | Example 2 | Example 3 | Example 4 | Example 5 | 1 |
| Polyether polyol | PP-2000 | 25.6 | 25.6 | 25.6 | 25.6 | 25.6 | 25.6 |
| Polyether polyol | PP-400 | 44.4 | 44.4 | 44.4 | 44.4 | 44.4 | 44.4 |
| Polycaprolactone polyol | PLACCEL205U | 13.0 | 13.0 | 13.0 | 13.0 | 13.0 | 13.0 |
| PPG + Fe catalyst (0.25%) | LT-Cat | 6.8 | 6.8 | 6.8 | 6.8 | 6.8 | 6.8 |
| Polymer polyol | EX-914 | 10.3 | 10.3 | 10.3 | 10.3 | 10.3 | 10.3 |
| Total of polyol components | | 100.1 | 100.1 | 100.1 | 100.1 | 100.1 | 100.1 |
| Foam stabilizer | SZ-1952 | 10.9 | 10.9 | 10.9 | 10.9 | 10.9 | 10.9 |
| Filler (aluminum hydroxide) | CW-325LV | 24.1 | 241 | 24.1 | 24.1 | 24.1 | 24.1 |
| Moisture absorbent (molecular sieve) | 3A MS | 2.4 | 2.4 | 2.4 | 2.4 | 2.4 | 2.4 |
| Antioxidant | IR-1135 | 0.3 | 0.3 | 0.3 | 0.3 | 0.3 | 0.3 |
| Total of polyol side | | 137.8 | 137.8 | 137.8 | 137.8 | 137.8 | 137.8 |
| Polymeric MDI (molar ratio) | 500B | 100.0 | 100.0 | 100.0 | 100.0 | 100.0 | 82.06 |
| MDI prepolymer (molar ratio) | MP-102 | 0.0 | 0.0 | 0.0 | 0.0 | 0.0 | 17.94 |
| Average number of functional groups | | 2.400 | 2.400 | 2.400 | 2.400 | 2.400 | 2.328 |
| Polymeric MDI (weight ratio) | 500B | 100 | 100 | 100 | 100 | 100 | 80 |
| MDI prepolymer (weight ratio) | MP-102 | 0 | 0 | 0 | 0 | 0 | 20 |
| Index | | 100 | 94 | 91 | 88 | 85 | 100 |
| Isocyanate addition amount (with | | 39.7 | 37.2 | 36.0 | 34.8 | 33.7 | 44.0 |
| respect to 100 parts of polyol) | | | | | | | |
| SR properties: recovery speed | (s) | 5.33 | 9.14 | 11.06 | 12.50 | 33.19 | 6.02 |
| Number of branches | (number/mol) | 0.0587 | 0.0552 | 0.0534 | 0.0517 | 0.0499 | 0.0500 |
| Compressive residual strain | (%) | 1.4 | 1.7 | 1.7 | 1.9 | 2.2 | 1.0 |
| Density | (kg/m3) | 314 | 320 | 325 | 326 | 344 | 309 |
| Tensile strength | (MPa) | 0.403 | 0.298 | 0.257 | 0.210 | 0.177 | 0.585 |
| Elongation | (%) | 164 | 181 | 193 | 228 | 298 | 215 |

| | | Example | Example | Example | Example | Example | Example |
|---|---|---|---|---|---|---|---|
| | | 2 | 3 | 4 | 5 | 6 | 7 |
| Polyether polyol | PP-2000 | 25.6 | 25.6 | 25.6 | 25.6 | 25.6 | 25.6 |
| Polyether polyol | PP-400 | 44.4 | 44.4 | 44.4 | 44.4 | 44.4 | 44.4 |
| Polycaprolactone polyol | PLACCEL205U | 13.0 | 13.0 | 13.0 | 13.0 | 13.0 | 13.0 |
| PPG + Fe catalyst (0.25%) | LT-Cat | 6.8 | 6.8 | 6.8 | 6.8 | 6.8 | 6.8 |
| Polymer polyol | EX-914 | 10.3 | 10.3 | 10.3 | 10.3 | 10.3 | 10.3 |
| Total of polyol components | | 100.1 | 100.1 | 100.1 | 100.1 | 100.1 | 100.1 |
| Foam stabilizer | SZ-1952 | 10.9 | 10.9 | 10.9 | 10.9 | 10.9 | 10.9 |
| Filler (aluminum hydroxide) | CW-325LV | 24.1 | 24.1 | 241 | 24.1 | 24.1 | 24.1 |
| Moisture absorbent (molecular sieve) | 3A MS | 2.4 | 2.4 | 2.4 | 2.4 | 2.4 | 2.4 |
| Antioxidant | IR-1135 | 0.3 | 0.3 | 0.3 | 0.3 | 0.3 | 0.3 |
| Total of polyol side | | 137.8 | 137.8 | 137.8 | 137.8 | 137.8 | 137.8 |
| Polymeric MDI (molar ratio) | 500B | 72.74 | 63.18 | 53.35 | 43.26 | 32.89 | 22.24 |
| MDI prepolymer (molar ratio) | MP-102 | 27.26 | 36.82 | 46.65 | 56.74 | 67.11 | 77.76 |
| Average number of functional groups | | 2.291 | 2.253 | 2.213 | 2.173 | 2.132 | 2.089 |
| Polymeric MDI (weight ratio) | 500B | 70 | 60 | 50 | 40 | 30 | 20 |
| MDI prepolymer (weight ratio) | MP-102 | 30 | 40 | 50 | 60 | 70 | 80 |
| Index | | 100 | 100 | 100 | 100 | 100 | 100 |
| Isocyanate addition amount (with | | 45.5 | 47.1 | 48.6 | 50.1 | 51.7 | 53.2 |
| respect to 100 parts of polyol) | | | | | | | |
| SR properties: recovery speed | (s) | 8.16 | 9.21 | 10.82 | 12.98 | 19.38 | 33.78 |
| Number of branches | (number/mol) | 0.0453 | 0.0403 | 0.0350 | 0.0296 | 0.0239 | 0.0180 |
| Compressive residual strain | (%) | 1.2 | 1.3 | 1.3 | 1.8 | 2.4 | 2.7 |
| Density | (kg/m3) | 303 | 307 | 309 | 312 | 312 | 313 |
| Tensile strength | (MPa) | 0.581 | 0.571 | 0.632 | 0.679 | 0.720 | 0.690 |
| Elongation | (%) | 226 | 236 | 286 | 319 | 383 | 472 |

TABLE 3

| | | Example | Example | Example | Example | Example | Example |
|---|---|---|---|---|---|---|---|
| | | 8 | 9 | 10 | 11 | 12 | 13 |
| Polyether polyol | PP-2000 | 25.6 | 25.6 | 25.6 | 25.6 | 25.6 | 25.6 |
| Polyether polyol | PP-400 | 44.4 | 44.4 | 44.4 | 44.4 | 44.4 | 44.4 |
| Polycaprolactone polyol | PLACCEL2050 | 13.0 | 13.0 | 13.0 | 13.0 | 13.0 | 13.0 |
| PPG + Fe catalyst (0.25%) | LT-Cat | 6.8 | 6.8 | 6.8 | 6.8 | 6.8 | 6.8 |
| Polymer polyol | EX-914 | 10.3 | 10.3 | 10.3 | 10.3 | 10.3 | 10.3 |
| Total of polyol components | | 100.1 | 100.1 | 100.1 | 100.1 | 100.1 | 100.1 |
| Foam stabilizer | SZ-1952 | 10.9 | 10.9 | 10.9 | 10.9 | 10.9 | 10.9 |
| Filler (aluminum hydroxide) | GW-325LV | 24.1 | 24.1 | 24.1 | 24.1 | 24.1 | 24.1 |
| Moisture absorbent (molecular sieve) | 3A MS | 2.4 | 2.4 | 2.4 | 2.4 | 2.4 | 2.4 |
| Antioxidant | IR-1135 | 0.3 | 0.3 | 0.3 | 0.3 | 0.3 | 0.3 |
| Total of polyol side | | 137.8 | 137.8 | 137.8 | 137.8 | 137.8 | 137.8 |
| Polymeric MDI (molar ratio) | 500B | 82.06 | 72.74 | 63.18 | 53.35 | 43.26 | 32.89 |
| MDI prepolymer (molar ratio) | MP-102 | 17.94 | 27.26 | 36.82 | 46.65 | 56.74 | 67.11 |
| Average number of functional groups | | 2.328 | 2.291 | 2.253 | 2.213 | 2.173 | 2.132 |
| Polymeric MDI (weight ratio) | 500B | 80 | 70 | 60 | 50 | 40 | 30 |
| MDI prepolymer (weight ratio) | MP-102 | 20 | 30 | 40 | 50 | 60 | 70 |
| Index | | 113 | 113 | 113 | 113 | 113 | 113 |
| Isocyanate addition amount (with | | 49.7 | 51.4 | 53.2 | 54.9 | 56.7 | 58.4 |
| respect to 100 parts of polyol) | | | | | | | |
| SR properties: recovery speed | (s) | 6.08 | 6.63 | 8.38 | 8.37 | 11.55 | 10.82 |
| Number of branches | (number/mol) | 0.0558 | 0.0504 | 0.0448 | 0.0389 | 0.0327 | 0.0263 |
| Compressive residual strain | (%) | 0.9 | 1.1 | 1.1 | 1.2 | 1.4 | 2.3 |
| Density | (kg/m3) | 301 | 292 | 297 | 296 | 292 | 290 |
| Tensile strength | (MPa) | 0.654 | 0.723 | 0.798 | 0.819 | 0.821 | 0.936 |
| Elongation | (%) | 206 | 218 | 246 | 275 | 316 | 327 |
| | | Example | Example | Example | Example | Example | Example |
| | | 14 | 15 | 16 | 17 | 18 | 19 |
| Polyether polyol | PP-2000 | 25.6 | 25.6 | 25.6 | 25.6 | 25.6 | 25.6 |
| Polyether polyol | PP-400 | 44.4 | 44.4 | 44.4 | 44.4 | 44.4 | 44.4 |
| Polycaprolactone polyol | PLACCEL2050 | 13.0 | 13.0 | 13.0 | 13.0 | 13.0 | 13.0 |
| PPG + Fe catalyst (0.25%) | LT-Cat | 6.8 | 6.8 | 6.8 | 6.8 | 6.8 | 6.8 |
| Polymer polyol | EX-914 | 10.3 | 10.3 | 10.3 | 10.3 | 10.3 | 10.3 |
| Total of polyol components | | 100.1 | 100.1 | 100.1 | 100.1 | 100.1 | 100.1 |
| Foam stabilizer | SZ-1952 | 10.9 | 10.9 | 10.9 | 10.9 | 10.9 | 10.9 |
| Filler (aluminum hydroxide) | GW-325LV | 24.1 | 24.1 | 24.1 | 24.1 | 24.1 | 24.1 |
| Moisture absorbent (molecular sieve) | 3A MS | 2.4 | 2.4 | 2.4 | 2.4 | 2.4 | 2.4 |
| Antioxidant | IR-1135 | 0.3 | 0.3 | 0.3 | 0.3 | 0.3 | 0.3 |
| Total of polyol side | | 137.8 | 137.8 | 137.8 | 137.8 | 137.8 | 137.8 |
| Polymeric MDI (molar ratio) | 500B | 22.24 | 82.06 | 72.74 | 63.18 | 53.35 | 43.26 |
| MDI prepolymer (molar ratio) | MP-102 | 77.76 | 17.94 | 27.26 | 36.82 | 46.65 | 56.74 |
| Average number of functional groups | | 2.089 | 2.328 | 2.291 | 2.253 | 2.213 | 2.173 |
| Polymeric MDI (weight ratio) | 500B | 20 | 80 | 70 | 60 | 50 | 40 |
| MDI prepolymer (weight ratio) | MP-102 | 80 | 20 | 30 | 40 | 50 | 60 |
| Index | | 113 | 94 | 94 | 94 | 94 | 94 |
| Isocyanate addition amount (with | | 60.1 | 41.3 | 42.8 | 44.2 | 45.7 | 47.1 |
| respect to 100 parts of polyol) | | | | | | | |
| SR properties: recovery speed | (s) | 13.20 | 7.07 | 10.74 | 11.61 | 9.99 | 16.01 |
| Number of branches | (number/mol) | 0.0197 | 0.0474 | 0.0429 | 0.0382 | 0.0333 | 0.0282 |
| Compressive residual strain | (%) | 3.7 | 1.7 | 1.6 | 1.7 | 2.5 | 4.9 |
| Density | (kg/m3) | 290 | 329 | 327 | 333 | 346 | 354 |
| Tensile strength | (MPa) | 0.931 | 0.321 | 0.367 | 0.385 | 0.382 | 0.417 |
| Elongation | (%) | 387 | 221 | 254 | 286 | 323 | 395 |

TABLE 4

| | | Comparative | Comparative | Example | Example | Example | Example |
|---|---|---|---|---|---|---|---|
| | | Example 6 | Example 7 | 20 | 21 | 22 | 23 |
| Polyether polyol | PP-2000 | 19.0 | 19.0 | 24.3 | 24.3 | 24.3 | 24.3 |
| Polyether polyol | PP-400 | 44.9 | 44.9 | 36.9 | 36.9 | 36.9 | 36.9 |
| CSR-dispersed polyol (PP-400) | MX-714 | 0.0 | 0.0 | 5.2 | 5.2 | 5.2 | 5.2 |
| Polycaprolactone polyol | PLACCEL205U | 12.2 | 12.2 | 12.3 | 12.3 | 12.3 | 12.3 |
| Polycaprolactone polyol | PLACCEL305 | 0.0 | 0.0 | 5.2 | 5.2 | 5.2 | 5.2 |
| PPG + Fe catalyst (0.25%) | LT-Cat | 11.8 | 11.8 | 6.4 | 6.4 | 6.4 | 6.4 |
| Polymer polyol | EX-914 | 12.1 | 12.1 | 9.8 | 9.8 | 9.8 | 9.8 |
| Total of polyol components | | 100.0 | 100.0 | 100.0 | 100.0 | 100.0 | 100.0 |
| Foam stabilizer | SZ-1952 | 11.2 | 11.2 | 10.4 | 10.4 | 10.4 | 10.4 |
| Filler (aluminum hydroxide) | CW-325LV | 22.7 | 22.7 | 22.9 | 22.9 | 22.9 | 22.9 |
| Moisture absorbent (molecular sieve) | 3A MS | 2.3 | 2.3 | 2.3 | 2.3 | 2.3 | 2.3 |
| Antioxidant | IR-1135 | 0.1 | 0.1 | 0.3 | 0.3 | 0.3 | 0.3 |
| Total of polyol side | | 136.2 | 136.2 | 135.8 | 135.8 | 135.8 | 135.8 |
| Polymeric MDI (molar ratio) | 500B | 100 | 100 | 33 | 33 | 33 | 33 |
| MDI prepolymer (molar ratio) | MP-102 | 0 | 0 | 67 | 67 | 67 | 67 |
| Average number of functional groups | | 2.40 | 2.40 | 2.13 | 2.13 | 2.13 | 2.13 |
| Polymeric MDI (mass ratio) | 500B | 100 | 100 | 30 | 30 | 30 | 30 |
| MDI prepolymer (mass ratio) | MP-102 | 0 | 0 | 70 | 70 | 70 | 70 |
| Index | | 94 | 94 | 95 | 98 | 103 | 95 |
| Isocyanate addition amount (with | | 36.3 | 36.3 | 51.0 | 52.6 | 55.3 | 51.0 |
| respect to 100 parts of polyol) | | | | | | | |
| SR properties: recovery speed | (s) | 6.5 | 1.8 | 102.7 | 30.7 | 7.0 | 23.4 |
| Compressive residual strain | (%) | 1.0 | 0.9 | 11.9 | 3.7 | 1.6 | 10.8 |
| Density | (kg/m3) | 150 | 200 | 150 | 150 | 150 | 200 |
| 180° peel strength | (N/24 mm) | 6 | 5 | 9 | 9 | 12 | 11 |
| Shear strength | (N) | 79 | 102 | 59 | 72 | 119 | 88 |
| 25% CLD | (MPa) | 0.004 | 0.006 | 0.002 | 0.003 | 0.004 | 0.005 |

| | | Example | Example | Example | Example | Example | Example |
|---|---|---|---|---|---|---|---|
| | | 24 | 25 | 26 | 27 | 28 | 29 |
| Polyether polyol | PP-2000 | 24.3 | 24.3 | 24.3 | 24.3 | 24.3 | 24.3 |
| Polyether polyol | PP-400 | 36.9 | 36.9 | 36.9 | 36.9 | 36.9 | 36.9 |
| CSR-dispersed polyol (PP-400) | MX-714 | 5.2 | 5.2 | 5.2 | 5.2 | 5.2 | 5.2 |
| Polycaprolactone polyol | PLACCEL205U | 12.3 | 12.3 | 12.3 | 12.3 | 12.3 | 12.3 |
| Polycaprolactone polyol | PLACCEL305 | 5.2 | 5.2 | 5.2 | 5.2 | 5.2 | 5.2 |
| PPG + Fe catalyst (0.25%) | LT-Cat | 6.4 | 6.4 | 6.4 | 6.4 | 6.4 | 6.4 |
| Polymer polyol | EX-914 | 9.8 | 9.8 | 9.8 | 9.8 | 9.8 | 9.8 |
| Total of polyol components | | 100.0 | 100.0 | 100.0 | 100.0 | 100.0 | 100.0 |
| Foam stabilizer | SZ-1952 | 10.4 | 10.4 | 10.4 | 10.4 | 10.4 | 10.4 |
| Filler (aluminum hydroxide) | CW-325LV | 22.9 | 22.9 | 22.9 | 22.9 | 22.9 | 22.9 |
| Moisture absorbent (molecular sieve) | 3A MS | 2.3 | 2.3 | 2.3 | 2.3 | 2.3 | 2.3 |
| Antioxidant | IR-1135 | 0.3 | 0.3 | 0.3 | 0.3 | 0.3 | 0.3 |
| Total of polyol side | | 135.8 | 135.8 | 135.8 | 135.8 | 135.8 | 135.8 |
| Polymeric MDI (molar ratio) | 500B | 33 | 33 | 33 | 33 | 33 | 33 |
| MDI prepolymer (molar ratio) | MP-102 | 67 | 67 | 67 | 67 | 67 | 67 |
| Average number of functional groups | | 2.13 | 2.13 | 2.13 | 2.13 | 2.13 | 2.13 |
| Polymeric MDI (mass ratio) | 500B | 30 | 30 | 30 | 30 | 30 | 30 |
| MDI prepolymer (mass ratio) | MP-102 | 70 | 70 | 70 | 70 | 70 | 70 |
| Index | | 98 | 103 | 103 | 103 | 95 | 103 |
| Isocyanate addition amount (with | | 52.6 | 55.3 | 55.3 | 55.3 | 51.0 | 55.3 |
| respect to 100 parts of polyol) | | | | | | | |
| SR properties: recovery speed | (s) | 9.3 | 4.0 | 1.5 | 1.5 | 9.0 | 1.5 |
| Compressive residual strain | (%) | 2.3 | 0.4 | 0.1 | 0.4 | 5.8 | 0.4 |
| Density | (kg/m3) | 200 | 200 | 240 | 300 | 320 | 400 |
| 180° peel strength | (N/24 mm) | 13 | 19 | 23 | 23 | 11 | 29 |
| Shear strength | (N) | 116 | 344 | 380 | 379 | 140 | 360 |
| 25% CLD | (MPa) | 0.006 | 0.015 | 0.023 | 0.042 | 0.010 | 0.080 |

Although the embodiments of the present invention have been described in detail above, the present invention is not limited to the above embodiments at all, and various modifications can be made without departing from the gist of the present invention.

### INDUSTRIAL APPLICABILITY

The low-resilience polyurethane foam according to the present invention can be used for shock-absorbing materials, protective mats, cushioning materials, vibration-absorbing materials, shoe insoles, shoe sole cushions, pillow cushions, seat cushions, chair cushions, and bedding cushions.

Further, the low-resilience polyurethane foam according to the present invention can be used as a cushioning material for electronic and electric devices such as
(a) a cushioning material that is disposed on a back surface side of various image display devices such as a liquid crystal display and absorbs an impact applied to the display device, and
(b) a cushioning material for a display member such as a touch panel used for mobile communication devices (for example, a mobile phone, a smartphone, or a personal digital assistant), a camera, or a lens.

The low-resilience polyurethane foam according to the present invention can be used as a base material of an adhesive tape, a gasket, or a sealing material.

1. A low-resilience polyurethane foam, obtained by causing a reaction of a raw material composition containing a polyisocyanate component and a polyol component,
wherein the polyisocyanate component contains an n-functional isocyanate (n≥3) and a bifunctional isocyanate prepolymer, and
wherein a recovery speed is 1.5 seconds or more, the recovery speed being a time until a sample shape is restored when a load of 1 kg is applied to a compression surface having a diameter of 15 mm by a constant pressure loader for 5 seconds and then the load is released.

2. The low-resilience polyurethane foam according to claim 1, wherein the polyisocyanate component has an average number of functional groups of 2.05 or more.

3. The low-resilience polyurethane foam according to claim 1, wherein the polyol component contains:
one or more high molecular weight polyols, and
one or more low molecular weight polyols, wherein:
the high molecular weight polyols are polyols having a number average molecular weight of 1,000 or more, and
the low molecular weight polyols are polyols having a number average molecular weight or a molecular weight of less than 1,000.

4. The low-resilience polyurethane foam according to claim 3, wherein a number average molecular weight ratio of the polyol component is 2.0 or more,
wherein the number average molecular weight ratio of the polyol component is a ratio (=Mn_{Htotal}/Mn_{Ltotal}) of a total number average molecular weight (Mn_{Htotal}) of the high molecular weight polyols with respect to a total number average molecular weight (Mn_{Ltotal}) of the low molecular weight polyols.

5. The low-resilience polyurethane foam according to claim 3, wherein a total content of the low molecular weight polyol is from 40.0 mass % to 75.0 mass %,
wherein the total content of the low molecular weight polyols is a proportion (=W_{L}×100/W_{T}) of a total weight (W_{L}) of the low molecular weight polyols with respect to a total weight (W_{T}) of the polyol component.

6. The low-resilience polyurethane foam according to claim 1, having a thickness of 2.0 mm or less.

7. The low-resilience polyurethane foam according to claim 1, which is used as a cushioning material for electronic and electric devices.

8. The low-resilience polyurethane foam according to claim 1, wherein the polyol component contains:
one or more high molecular weight polyols, and
one or more low molecular weight polyols,
a total content of the low molecular weight polyols being from 40.0 to 70.0 mass %,
the polyisocyanate component having a weight ratio of the bifunctional isocyanate prepolymer of 20 or more and 80 or less,
the high molecular weight polyols being polyols having a number average molecular weight of 1,000 or more,
the low molecular weight polyol being polyols having a number average molecular weight or a molecular weight of less than 1,000,
the total content of low molecular weight polyols being a proportion (=W_{L}×100/W_{T}) of a total weight (W_{L}) of the low molecular weight polyols with respect to a total weight (W_{T}) of the polyol component, and
the weight ratio of the bifunctional isocyanate prepolymer being a weight of the bifunctional isocyanate prepolymer when a total weight of the polyisocyanate component is 100.

9. The low-resilience polyurethane foam according to claim 1, which is obtained by causing a reaction of the raw material composition using a mechanical frothing method.

10. The low-resilience polyurethane foam according to claim 1, containing a polycaprolactone polyol as the polyol component.

11. The low-resilience polyurethane foam according to claim 1, wherein the polyol component contains rubber particles in which a part or all of a surface of a particulate core component having a rubber-like polymer as a main component is coated with a shell component.

12. The low-resilience polyurethane foam according to claim 1, wherein the compressive residual strain is 5% or less,
the compressive residual strain being a value measured based on JIS K 6401:2011.

13. The low-resilience polyurethane foam according to claim 1, wherein the raw material composition further contains a moisture absorbent.

14. The low-resilience polyurethane foam according to claim 1, wherein the raw material composition further contains a filler.
